(19) United States
(12) Patent Application Publication
(10) Pub. No.: US 2022/0309967 A1
(43) Pub. Date: Sep. 29, 2022

(54) PROJECTION IMAGE ADJUSTMENT METHOD, INFORMATION PROCESSING DEVICE, AND PROJECTION SYSTEM

(71) Applicant: SEIKO EPSON CORPORATION, Tokyo (JP)

(72) Inventor: Yoichi SHISHIDO, Matsumoto-shi (JP)

(73) Assignee: SEIKO EPSON CORPORATION, Tokyo (JP)

(21) Appl. No.: 17/700,670

(22) Filed: Mar. 22, 2022

(30) Foreign Application Priority Data
Mar. 23, 2021 (JP) 2021-048258

(51) Int. Cl. G09G 3/00

(52) U.S. Cl. CPC G09G 3/002; G09G 2300/023; G09G 2354/00; G09G 2340/04

(57) ABSTRACT

A projection image adjustment method includes, acquiring projection information including first arrangement information corresponding to a number of a plurality of partial images projected on a projection surface from a plurality of projectors, the plurality of partial images arranged in a first direction in such a way as to partly overlap each other, deciding a number of a plurality of adjustment points in the first direction, based on the first arrangement information, projecting, by the plurality of projectors, an image for adjustment including the plurality of adjustment points, accepting an operation of moving the plurality of adjustment points included in the image for adjustment, changing a visual aspect of the image for adjustment, based on the operation and deciding a correction parameter for adjusting a visual aspect of the projection image, based on the change in the visual aspect of the image for adjustment.

The present application is based on, and claims priority from JP Application Serial Number 2021-048258, filed Mar. 23, 2021, the disclosure of which is hereby incorporated by reference herein in its entirety.

### BACKGROUND

### 1. Technical Field

The present disclosure relates to a projection image adjustment method, an information processing device, and a projection system.

### 2. Related Art

JP-A-2013-78001 describes a projector which projects an image including a plurality of control points, accepts a user's operation of moving a control point, and deforms the image according to the amount of movement of the control point. This projector enables the user to move a control point to a desired position and thus correct the mode of the image such as shape or distortion.

Meanwhile, JP-A-2010-224221 describes a multi-projection system which couples together partial images projected respectively from a plurality of projectors, on a projection surface, and thus displays a single large image. In such a system, the individual projectors are arranged in such a way that the ends of partial images next to each other overlap each other so that a plurality of partial images are coupled together seamlessly.

In the case of correcting the mode of the image projected by the multi-projection system described in JP-A-2010-224221 using the technique described in JP-A-2013-78001, the control points may not be arranged in the overlap area where partial images overlap each other, depending on the combination of the number of partial images and the number of control points arranged. When the control points are not arranged in the overlap area, it is difficult to seamlessly couple together a plurality of partial images sharing this overlap area, in the overlap area.

### SUMMARY

A projection image adjustment method is a projection image adjustment method in which a mode of a projection image formed by a plurality of partial images projected on a projection surface from a plurality of projectors and arranged in a first direction in such a way as to partly overlap each other is adjusted using an image for adjustment including a plurality of adjustment points. The method includes: acquiring projection information including first arrangement information corresponding to a number of the partial images arranged in the first direction; deciding a number of the adjustment points in the first direction in such a way that the adjustment points are arranged in an overlap area where the partial images overlap each other, based on the first arrangement information; causing the plurality of projectors to project the image for adjustment where the decided number of adjustment points are arranged in the first direction, as the projection image on the projection surface; accepting an operation of moving the adjustment point included in the projected image for adjustment; changing a mode of the projected image for adjustment, based on the accepted operation; and deciding a correction parameter for adjusting a mode of the projection image, based on the change in the mode of the image for adjustment.

An information processing device includes a control unit adjusting a mode of a projection image formed by a plurality of partial images projected on a projection surface from a plurality of projectors and arranged in a first direction in such a way as to partly overlap each other, using an image for adjustment including a plurality of adjustment points. The control unit executes: acquiring projection information including first arrangement information corresponding to a number of the partial images arranged in the first direction; deciding a number of the adjustment points in the first direction in such a way that the adjustment points are arranged in an overlap area where the partial images overlap each other, based on the first arrangement information; causing the plurality of projectors to project the image for adjustment where the decided number of adjustment points are arranged in the first direction, as the projection image on the projection surface; accepting an operation of moving the adjustment point included in the projected image for adjustment; changing a mode of the projected image for adjustment, based on the accepted operation; and controlling a decision about a correction parameter for adjusting a mode of the projection image, based on the change in the mode of the image for adjustment.

A projection system includes a plurality of projectors, and an information processing device having a control unit adjusting a mode of a projection image formed by a plurality of partial images projected on a projection surface from the plurality of projectors and arranged in a first direction in such a way as to partly overlap each other, using an image for adjustment including a plurality of adjustment points. The control unit executes: acquiring projection information including first arrangement information corresponding to a number of the partial images arranged in the first direction; deciding a number of the adjustment points in the first direction in such a way that the adjustment points are arranged in an overlap area where the partial images overlap each other, based on the first arrangement information; causing the plurality of projectors to project the image for adjustment where the decided number of adjustment points are arranged in the first direction, as the projection image on the projection surface; accepting an operation of moving the adjustment point included in the projected image for adjustment; changing a mode of the projected image for adjustment, based on the accepted operation; and controlling a decision about a correction parameter for adjusting a mode of the projection image, based on the change in the mode of the image for adjustment.

### BRIEF DESCRIPTION OF THE DRAWINGS

FIG. 1 is an explanatory view showing a projection system according to a first embodiment.

FIG. 2 is a block diagram showing a schematic configuration of the projection system and the internal configuration of a computer.

FIG. 3 is a block diagram showing the internal configuration of a projector.

FIG. 4 is a block diagram showing a schematic configuration of a projection unit.

FIG. 5 is a flowchart for explaining projection image adjustment processing.

FIG. 6 is a flowchart for explaining projection area coupling processing.

FIG. 7A is a schematic view showing an example of a pattern image for measurement.

FIG. 7B is a schematic view showing an example of a first picked-up image.

FIG. 7C is a schematic view showing an example of a second picked-up image.

FIG. 8 is a schematic view showing an example of an image for adjustment.

FIG. 9 is a schematic view showing the image for adjustment projected on a projection surface.

FIG. 10 is a schematic view showing the image for adjustment projected on the projection surface.

FIG. 11 is a schematic view showing the image for adjustment projected on the projection surface.

FIG. 12 is a schematic view showing another example of the image for adjustment.

FIG. 13 is a schematic view showing an example of a menu image.

### DESCRIPTION OF EXEMPLARY EMBODIMENTS

### 1. First Embodiment

A projection system according to a first embodiment will now be described with reference to the drawings.

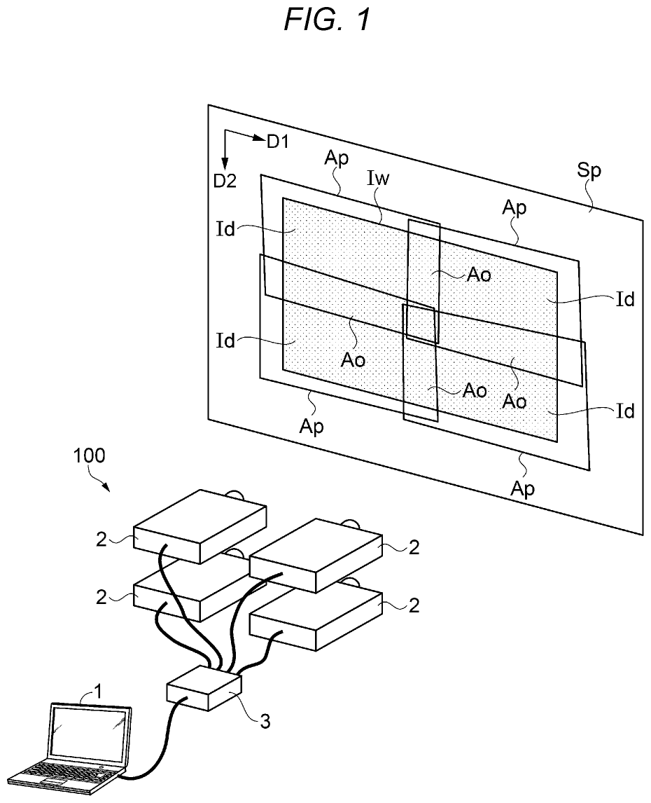

FIG. 1 is an explanatory view showing a projection system 100 according to this embodiment.

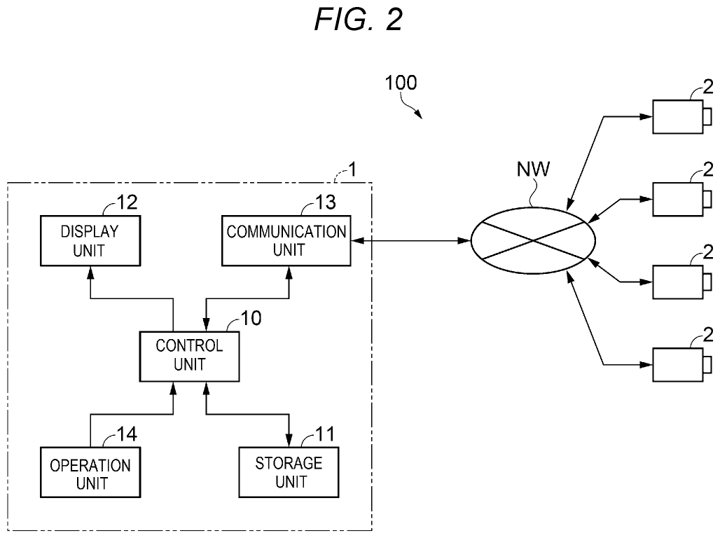

As shown in FIG. 1, the projection system 100 has a computer 1, which is an information processing device, and a plurality of projectors 2 projecting an image on a projection surface Sp such as a screen or a wall surface. Each of the plurality of projectors 2, and the computer 1, are connected to a network NW shown in FIG. 2 via a hub 3. The computer 1 controls the operation of each projector 2 via the network NW. The plurality of projectors 2 are installed in such a way that images projected from the individual projectors 2 are arranged next to each other so that the projectors 2 can display a single large image in cooperation with each other. Hereinafter, an image projected individually by each projector 2 is referred to as a “partial image Id” and a large image formed by partial images coupled together is referred to as a “full image Iw”. The full image Iw is equivalent to a projection image. Also, the action of displaying one full image Iw by the plurality of projectors 2 in cooperation with each other is referred to as “multi-projection”.

In the multi-projection according to this embodiment, four projectors 2 are arranged and four partial images Id projected from these projectors 2 are arranged in the form of a matrix having two lines along a first direction D1 and two lines along a second direction D2 intersecting the first direction D1. These four partial images Id form the full image Iw. In this embodiment, the first direction D1 is parallel to the horizontal direction, and the second direction D2 is parallel to the vertical direction. However, the first direction D1 and the second direction D2 are not limited to these directions. The arrangement of the partial images Id is not limited to the above example, either. A matrix having one or more lines along the first direction D1 and one or more lines along the second direction D2 and having a plurality of lines along at least one of these directions may be employed.

Each projector 2 displays the partial image Id in a partial range in a projection area Ap where an image can be projected. Typically, each projector 2 displays the partial image Id in such a range in the projection area Ap that the full image Iw can be viewed as a rectangle in a desired size. Each projector 2 is installed in such a way that a part of the projection area Ap of the projector 2 overlaps a part of the next projection area Ap. That is, each projector 2 is installed in such a way that a part of the partial image Id projected by the projector 2 overlaps a part of the next partial image Id. Therefore, the full image 1w can be displayed in the state where the partial images Id are smoothly coupled together without any gap between the partial images Id. In this way, in this embodiment, the full image Iw is formed by the four partial images Id projected on the projection surface Sp from the four projectors 2 and arranged in the first direction D1 and the second direction D2 in such a way as to partly overlap each other. In this specification, an area Ao where the partial images Id overlap each other is referred to as an “overlap area Ao”. Also, in this specification, that the partial images Id and the projection areas Ap are “next to each other” means that the partial images Id and the projection areas Ap are next to each other along the first direction D1 or the second direction D2.

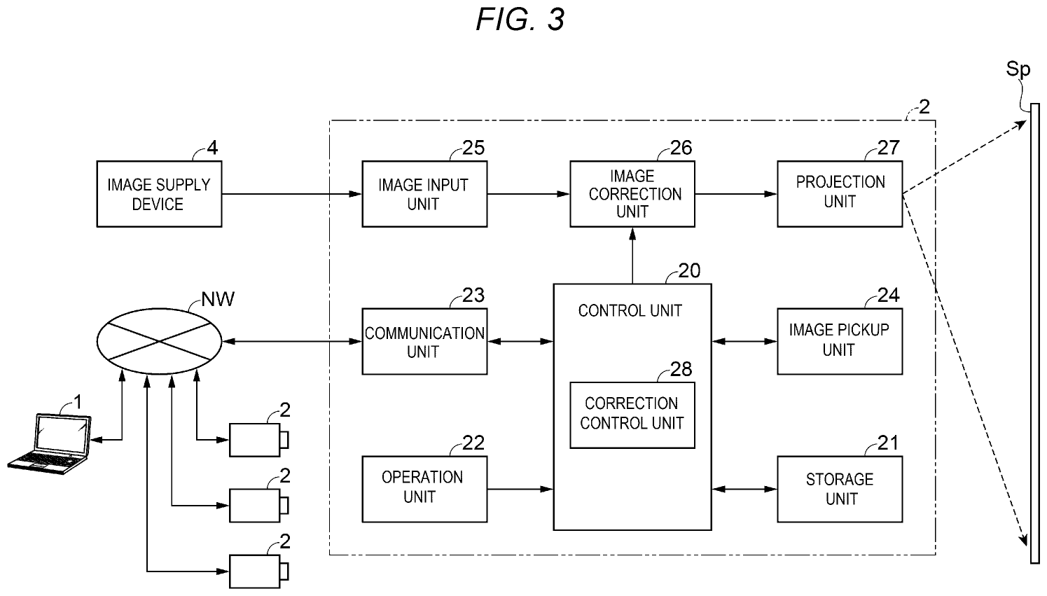

The configuration of the projection system 100 shown in FIG. 1 is necessary for initial setting of the projector 2. When subsequently displaying a desired content image as the full image Iw, an external image supply device 4 shown in FIG. 3 is coupled to each projector 2 and supplies image data corresponding to the content image.

FIG. 2 is a block diagram showing a schematic configuration of the projection system 100 and the internal configuration of the computer 1.

As shown in FIG. 2, the computer 1 has a control unit 10, a storage unit 11, a display unit 12, a communication unit 13, and an operation unit 14.

The control unit 10 includes one or a plurality of processors, a RAM (random-access memory), and a ROM (read-only memory) or the like. The control unit 10 operates according to a program stored in the ROM or a program read out to the RAM from the storage unit 11 and thus comprehensively controls the operation of the computer 1.

The storage unit 11 has a storage device such as a hard disk drive or a solid-state drive. The storage unit 11 stores an OS (operating system) and an application program installed therein, and various data or the like. In the storage unit 11 in this embodiment, a projection image adjustment program, not illustrated, is installed. The projection image adjustment program is an application program for adjusting the mode of the full image Iw such as the shape of the full image Iw displayed by multi-projection.

The display unit 12 has a display device such as a liquid crystal display or an organic EL (electroluminescence) display and displays an image under the control of the control unit 10.

The communication unit 13 has various circuits for communicating with an external device via the network NW. The communication unit 13 in this embodiment communicates with the plurality of projectors 2 connected via the network NW, under the control of the control unit 10. The form of communication may be wired communication or wireless communication.

The operation unit 14 includes a keyboard and a pointing device or the like. The operation unit 14 accepts various input operations by a user and outputs information corresponding to the input operations, to the control unit 10. As the pointing device, a mouse, a touch pad or the like can be used.

When the configuration including the control unit 10, of the foregoing components, is assumed as the main body of the computer 1, the other components than the control unit 10 may be not formed integrally with the main body of the computer 1.

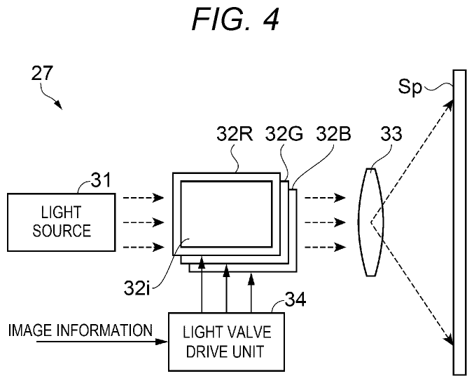

FIG. 3 is a block diagram showing the internal configuration of the projector 2. FIG. 4 is a block diagram showing a schematic configuration of a projection unit 27 provided in the projector 2. In this embodiment, the plurality of projectors 2 have the same configuration.

As shown in FIG. 3, the projector 2 has a control unit 20, a storage unit 21, an operation unit 22, a communication unit 23, an image pickup unit 24, an image input unit 25, an image correction unit 26, and the projection unit 27, which are integrally formed. The projector 2 projects an image on the projection surface Sp from the projection unit 27, based on image data inputted to the image input unit 25.

The control unit 20 includes one or a plurality of processors. The control unit 20 operates according to a control program stored in the storage unit 21 and thus comprehensively controls the operation of the projector 2.

The storage unit 21 has a memory such as a RAM and a ROM. The RAM is used to temporarily store various data or the like. The ROM stores the control program and control data for controlling the operation of the projector 2, and image data or the like.

The operation unit 22 has a plurality of operation keys for the user to give various instructions to the projector 2. When the user operates the various operation keys of the operation unit 22, the operation unit 22 outputs an operation signal corresponding to the content of the user's operation to the control unit 20. Also, a remote controller, not illustrated, that can perform remote control may be used as the operation unit 22. In this case, the remote controller sends an infrared operation signal corresponding to the content of the user's operation, and a remote control signal receiving unit, not illustrated, receives this operation signal and transmits the operation signal to the control unit 20.

The communication unit 23 has various circuits for communicating with an external device via the network NW. The communication unit 23 in this embodiment is connected to the computer 1 and the other projectors 2 via the network NW and transmits and receives information to and from these devices, under the control of the control unit 20.

The image pickup unit 24 is a camera having an image pickup element, not illustrated, such as a CCD (charge-coupled device) sensor or a CMOS (complementary metal-oxide semiconductor) sensor. The image pickup unit 24 picks up an image of the projection surface Sp under the control of the control unit 20 and outputs picked-up image data, which is the result of the image pickup, to the control unit 20. The image pickup unit 24 picks up an image over a range including at least the projection area Ap of this projector 2. Therefore, when the projectors 2 are installed in such a way that the plurality of partial images Id partly overlap each other as shown in FIG. 1, the image pickup unit 24 can pick up an image of an area included at least in the overlap area Ao, in the next partial image Id.

The image input unit 25 is coupled to the external image supply device 4 such as an image playback device. The image input unit 25 receives image data corresponding to a content image supplied from the image supply device 4 and outputs the image data to the image correction unit 26.

The image correction unit 26, under the control of the control unit 20, performs correction processing on the image data inputted from the image input unit 25 and outputs the processed image data to a light valve drive unit 34 shown in FIG. 4, of the projection unit 27. For example, the image correction unit 26 performs geometric correction processing on the image data and thus corrects the mode of the partial image Id, that is, the contour shape of the partial image Id and a distortion of the image inside the contour. The image correction unit 26 can also acquire image data generated by the control unit 20 from the control unit 20 instead of the image data inputted from the image input unit 25 and then output this image data to the projection unit 27.

The image input unit 25 and the image correction unit 26 may be formed by one or a plurality of processors or may be formed by a dedicated processing device such as an ASIC (application-specific integrated circuit) or an FPGA (field-programmable gate array).

As shown in FIG. 4, the projection unit 27 has a light source 31, three liquid crystal light valves 32R, 32G, 32B as light modulation devices, an optical projection system 33, the light valve drive unit 34, and the like. The projection unit 27 modulates light emitted from the light source 31, by the liquid crystal light valves 32R, 32G, 32B, to form image light, then projects the image light from the optical projection system 33 including at least one of a lens and a mirror, and thus displays an image on the projection surface Sp.

The light source 31 includes a discharge-type light source lamp such as an ultra-high-pressure mercury lamp or a metal halide lamp, or a solid-state light source such as a light-emitting diode or a semiconductor laser. The light emitted from the light source 31 is converted into light having a substantially uniform luminance distribution by an optical integration system, not illustrated, and is separated into color light components of red, green, and blue, which are the three primary colors of light, by a color separation system, not illustrated. Subsequently, the color light components enter the corresponding liquid crystal light valves 32R, 32G, 32B.

Each of the liquid crystal light valves 32R, 32G, 32B is formed by a transmission-type liquid crystal panel or the like having a pair of transparent substrates with a liquid crystal enclosed between the substrates. In each liquid crystal panel, a rectangular pixel area 32i made up of a plurality of pixels arranged in the form of a matrix is formed. A drive voltage can be applied to the liquid crystal at each pixel.

The light valve drive unit 34 forms an image in the pixel area 32i of the liquid crystal light valves 32R, 32G, 32B. Specifically, the light valve drive unit 34 applies a drive voltage corresponding to the image data inputted from the image correction unit 26, to each pixel in the pixel area 32i, and thus sets each pixel to a light transmittance corresponding to the image data. The light emitted from the light source 31 is transmitted through the pixel area 32i of the liquid crystal light valves 32R, 32G, 32B and thus modulated for each pixel, forming image light corresponding to the image data for each color light. The image lights of the individual colors, thus formed, are combined together for each pixel by a light combining system, not illustrated, and thus form image light representing a color image. This image light is projected in an enlarged form on the projection surface Sp by the optical projection system 33. Thus, an image based on the image data inputted from the image correction unit 26 is displayed on the projection surface Sp.

Referring back to FIG. 3, the control unit 20 has a correction control unit 28 as a functional block implemented by the control program. The correction control unit 28 performs various kinds of processing to adjust the mode of the partial image Id to be projected and also controls the correction processing by the image correction unit 26. For example, the correction control unit 28 generates a correction parameter for the image correction unit 26 to geometrically correct the image data, based on the image picked up by the image pickup unit 24 and under the control of the computer 1. In this case, the correction control unit 28 outputs the generated correction parameter to the image correction unit 26 and causes the image correction unit 26 to perform correction processing based on the correction parameter. The correction control unit 28 also partly generates image data of an image for adjustment Da shown in FIG. 8 that is used for generating a correction parameter, under the control of the computer 1, and outputs the image data to the image correction unit 26 and causes the projection unit 27 to project the image for adjustment Da. Details of the image for adjustment Da will be described later.

A method for adjusting the full image Iw when the projection system 100 performs multi-projection will now be described.

First, the user installs each projector 2 in such a way that the projection area Ap of each projector 2 is in a proper state. Specifically, the user installs each projector 2 in such a way that the area formed by the projection areas Ap of the individual projectors 2 combined together covers the area where the full image Iw is to be displayed and that the projection areas Ap next to each other partly overlap each other, as shown in FIG. 1. Subsequently, when the user instructs the computer 1 to start the projection image adjustment program, the computer 1 starts projection image adjustment processing according to the projection image adjustment program.

The projection image adjustment processing is processing for adjusting the size, shape, distortion or the like of the full image Iw in a desired mode and is executed as initial processing, for example, when the multi-projection by the projection system 100 starts. The execution of this projection image adjustment processing enables the user to adjust, for example, the outline of the full image Iw to coincide with the outline of the screen when the screen is arranged inside the projection surface Sp. Also, for example, when the projection surface Sp is a curved surface, the user can make an adjustment to reduce the distortion of the image due to the curved surface.

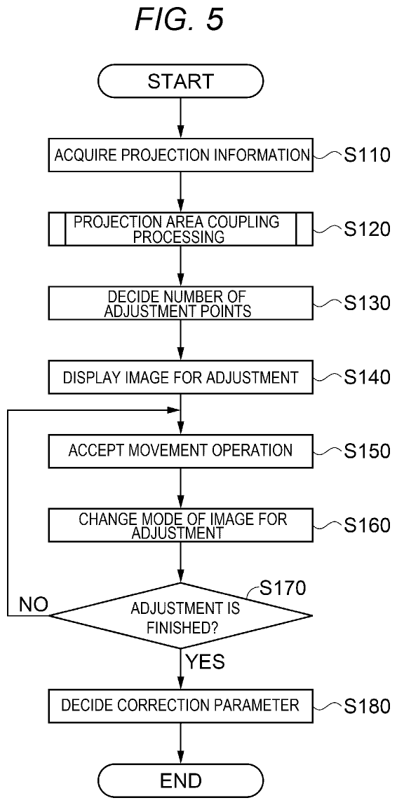

FIG. 5 is a flowchart for explaining the projection image adjustment processing.

As shown in FIG. 5, in step S110, the control unit 10 of the computer 1 acquires projection information about multi-projection from the user. The projection information includes first arrangement information representing the number of partial images Id arranged in the first direction D1 and second arrangement information representing the number of partial images Id arranged in the second direction D2 and also includes information representing which projector 2, of the plurality of projectors 2 connected to the network NW, projects a partial image Id at which position. Thus, the control unit 10 can recognize the arrangement of the partial images Id and the projector 2 corresponding to each partial image Id. The projection information may be automatically acquired by causing each projector 2 to project a predetermined test pattern and picking up an image of the test pattern, or the like. The first arrangement information and the second arrangement information representing the numbers of partial images Id can be replaced with information representing the number of projectors 2 projecting these partial images Id.

In this embodiment, the control unit 10 also acquires information about the density of arrangement of adjustment points Pa shown in FIG. 8 as a piece of projection information from the user. The adjustment point Pa is a target point for adjustment arranged in a plural number at or inside the boundary of the image for adjustment Da shown in FIG. 8 that is used for correcting the mode of the full image Iw. When the projection surface Sp is a planar surface, a proper geometric correction can be made even if the density of arrangement of the adjustment points Pa is low. However, when the projection surface Sp is a curved surface or an irregular surface, arranging the adjustment points Pa at a high density enables a fine correction. The control unit 10 acquires, as the projection information, first density information representing the density of arrangement in the first direction D1 and second density information representing the density of arrangement in the second direction D2 in addition to the first arrangement information and the second arrangement information. In this embodiment, the first density information and the second density information are natural numbers and are set in such a way that a greater numeric value means a higher density of arrangement.

In step S120, the control unit 10 executes projection area coupling processing of coupling the projection areas Ap of the individual projectors 2 together. The projection area coupling processing is processing of executing a geometric correction in which the positional relationship between the individual projection areas Ap is found and in which the coordinate systems of the projection areas Ap next to each other are coupled together, with respect to the coordinate system of each projection area Ap. The projection area coupling processing generates a single common coordinate system having the coordinate systems of the individual projection areas Ap coupled together on the projection surface Sp.

The execution of the projection area coupling processing of step S120 may be omitted, when there is a history of the execution of the projection area coupling processing in the past, the individual projection areas Ap are already coupled together, and a common coordinate system is already known. Also, step S120 may be omitted, for example, when each projector 2 is installed in a predetermined arrangement position and arrangement attitude in relation to the projection surface Sp in such a way that a predetermined common coordinate system is constructed on the projection surface Sp. The control unit 10 may display a message on the projection surface Sp and ask the user whether to execute the projection area coupling processing or not.

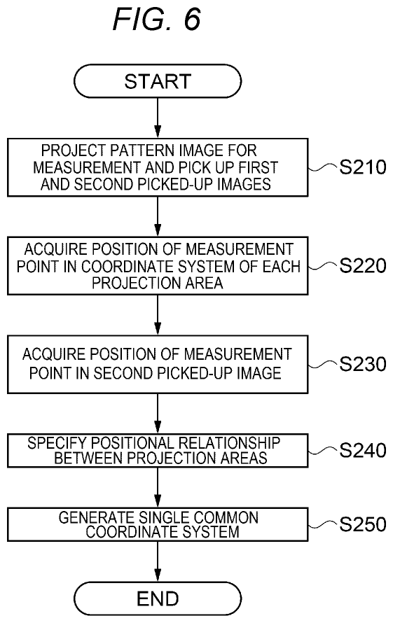

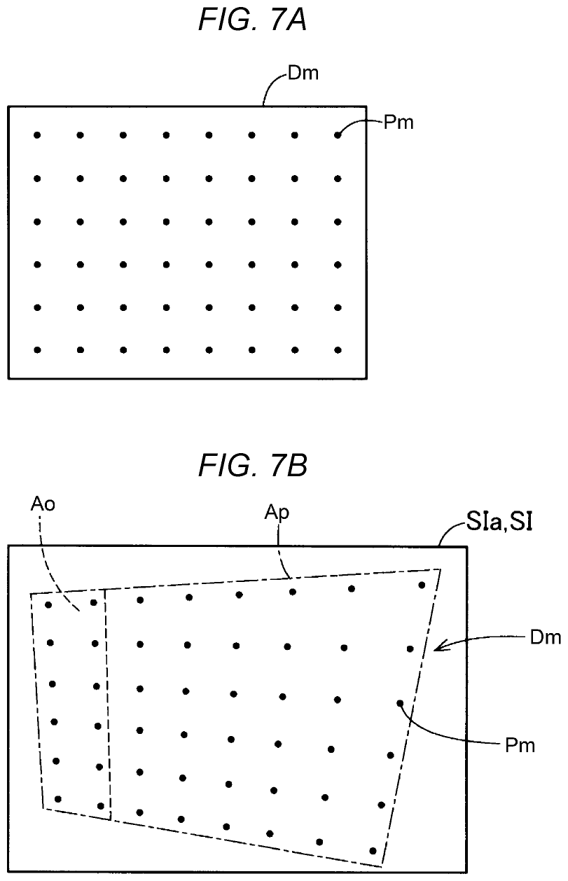

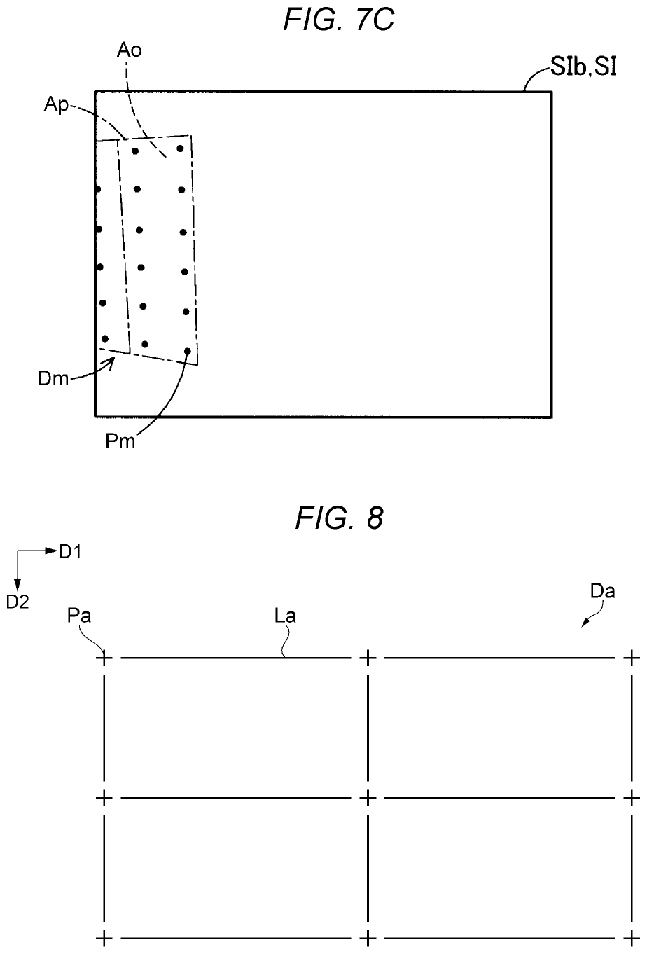

The projection area coupling processing will now be described with reference to FIGS. 6 and 7A to 7C. FIG. 6 is a flowchart for explaining the projection area coupling processing. In the projection area coupling processing in this embodiment, the control unit 10 causes each projector 2 to project a pattern image for measurement Dm shown in FIG. 7A and causes the image pickup unit 24 to pick up an image of the projection surface Sp where the pattern image for measurement Dm is projected. The control unit 10 couples together the projection areas Ap next to each other, using a picked-up image SI that is picked up, and generates a single coordinate system common to the individual projection areas Ap on the projection surface Sp.

In step S210, the control unit 10 sequentially instructs each projector 2 to project the pattern image for measurement Dm in the projection area Ap of each projector 2 and causes the image pickup unit 24 of each projector 2 to pick up an image of the pattern image for measurement Dm projected on the projection surface Sp. The picked-up image SI generated by the image pickup at this point is also referred to as a “first picked-up image SIa”.

FIG. 7A is a schematic view showing an example of the pattern image for measurement Dm. In the pattern image for measurement Dm, measurement points Pm serving as indicators showing predetermined coordinate positions are arranged in a dispersed manner. In the example shown in FIG. 7A, circular dot images representing the measurement points Pm are arranged at a predetermined interval and in the form of a matrix. The pattern image for measurement Dm is configured in such a way that such measurement points Pm are also projected in the overlap area Ao in the projection area Ap. FIG. 7B is a schematic view showing an example of the first picked-up image SIa. The first picked-up image SIa in FIG. 7B is a picked-up image SI picked up by the projector 2 projecting the pattern image for measurement Dm shown in FIG. 7A, using the image pickup unit 24 of the projector 2. The first picked-up image SIa shows a state where the measurement points Pm are arranged over the entire range of the projection area Ap.

The control unit 10 also instructs each projector 2 to pickup an image of the projection area Ap of the projector 2, using the image pickup unit 24 of this projector 2, when the pattern image for measurement Dm is projected in the projection area Ap next to the projection area Ap of this projector 2. The picked-up image SI generated by the image pickup at this point is also referred to as a “second picked-up image SIb”. FIG. 7C is a schematic view showing an example of the second picked-up image SIb. The second picked-up image SIb shows at least the measurement points Pm displayed in the overlap area Ao, of the pattern image for measurement Dm projected in the next projection area Ap. The second picked-up image SIb in FIG. 7C is a picked-up image SI picked up by the image pickup unit 24 when the projector 2 picking up the first picked-up image SIa shown in FIG. 7B does not project the pattern image for measurement Dm and the projector 2 located to the left projects the pattern image for measurement Dm.

It is desirable that, in step S210, the control unit 10 sets an order in which the individual projectors 2 project the pattern image for measurement Dm so that the pattern image for measurement Dm is not projected simultaneously in the projection areas Ap next to each other. Also, in step S210, the control unit 10 may perform control in such a way that the pattern image for measurement Dm is projected simultaneously in two or more projection areas Ap that are spaced apart from each other and not next to each other in the first direction D1 or the second direction D2. This enables a reduction in the processing time of step S210.

In step S220, the control unit 10 acquires, from each projector 2, the position of the measurement point Pm in the coordinate system of the projection area Ap of the projector 2. Specifically, the control unit 20 of each projector 2 analyzes the first picked-up image SIa and extracts the position of each measurement point Pm shown in the first picked-up image SIa. The control unit 20 then acquires the coordinate system of the projection area Ap, based on the coordinates of each extracted measurement point Pm on the image data, and calculates the coordinates of each measurement point Pm in the coordinate system of the projection area Ap, that is, the coordinates representing the display position of the measurement point Pm on the projection surface Sp. The result of the calculation is transmitted to the computer 1 via the communication unit 23 of each projector 2.

In step S230, the control unit 10 acquires the position of each measurement point Pm in the overlap area Ao in the second picked-up image SIb, from each projector 2. Specifically, the control unit 20 of each projector 2 analyzes the second picked-up image SIb and extracts the position of each measurement point Pm in the overlap area Ao shown in the second picked-up image SIb. The result of the extraction is transmitted to the computer 1 via the communication unit 23 of each projector 2.

In step S240, the control unit 10 establishes a correspondence between the coordinates of the measurement point Pm in the coordinate system of each projection area Ap acquired from the first picked-up image SIa and the information about the position of the measurement point Pm shown in the overlap area Ao acquired from the second picked-up image SIb. Thus, the control unit 10 specifies the positional relationship between the projection areas Ap next to each other. The control unit 10 transmits information representing the positional relationship between the projection areas Ap next to each other, to each corresponding projector 2. The “information representing the positional relationship between the projection areas Ap next to each other” is information representing the relative positional relationship between the display positions of the pixels in the overlap area Ao between the projection areas Ap next to each other. In this way, in steps S210 to S240, the positional relationship between the projection areas Ap of the plurality of projectors 2 is found, using the measurement point Pm in the overlap area Ao shown in the picked-up image SI picked up by the image pickup unit 24 of each of the plurality of projectors 2, as an indicator.

In step S250, the correction control unit 28 of each projector 2 decides a correction parameter for geometric correction for converting the coordinate system of each projection area Ap, based on the information representing the positional relationship between the projection areas Ap next to each other transmitted from the control unit 10. Specifically, the correction control unit 28 calculates a correction parameter for geometric correction in such a way that the display position of the pixel in the projection area Ap coincides with the display position of the pixel in the next projection area Ap, in the overlap area Ao, and outputs the correction parameter to the image correction unit 26. Thus, the coordinate systems of the projection areas Ap next to each other are coupled together and a single common coordinate system having the coordinate systems of the individual projection areas Ap coupled together on the projection surface Sp is generated. From this point onward, the control unit 10 of the computer 1 can designate a position to each projector 2, using this common coordinate system.

Referring back to FIG. 5, in step S130, the control unit 10 decides the number of adjustment points Pa for adjusting the mode of the full image Iw, based on the projection information acquired in step S110. Specifically, the control unit 10 decides c×m+1 as the number of adjustment points Pa along the first direction D1 and b×n+1 as the number of adjustment points Pa along the second direction D2, where c is the number of partial images Id along the first direction D1, b is the number of partial images Id along the second direction D2, m is a natural number expressing the first density information representing the density of arrangement in the first direction D1, and n is a natural number expressing the second density information representing the density of arrangement in the second direction D2. That is, the number of adjustment points Pa along each direction is the number of partial images Id along the direction multiplied by the natural number plus 1. In this embodiment, it is assumed that both the number of partial images Id along the first direction D1 and the number of partial images Id along the second direction D2 are 2 and that both the first density information and the second density information are set to 1. In this case, the number of adjustment points Pa is 3 in both the first direction D1 and the second direction D2 and the total number is 3×3=9. The first density information and the second density information need not be the same value and may differ from each other.

In step S140, the control unit 10 controls each projector 2 to display the image for adjustment Da shown in FIG. 8 for adjusting the mode of the full image Iw, on the projection surface Sp by multi-projection.

As shown in FIG. 8, the image for adjustment Da is a substantially rectangular image displayed as the full image Iw and an image where the adjustment points Pa the number of which is decided in step S130 are arranged in the form of a matrix along the first direction D1 and the second direction D2. In this embodiment, the adjustment point Pa is cross-shaped. However, the shape of the adjustment point Pa is not limited to the cross shape and various other shapes can be employed. The adjustment points Pa are arranged at equal intervals in each of the first direction D1 and the second direction D2. However, the interval in the first direction D1 and the interval in the second direction D2 differ from each other due to the aspect ratio of the full image Iw. In the image for adjustment Da, straight auxiliary lines La are arranged in the form of a grid so as to connect the adjustment points Pa next to each other. In this embodiment, the image for adjustment Dais an image having a single-color background against which the adjustment points Pa and the auxiliary lines La in a different color from the background are arranged. However, a meaningful image may be used as the background. In this case, the adjustment points Pa and the auxiliary lines La may be hemmed in a different color so as not to reduce the visibility of the adjustment points Pa and the auxiliary lines La.

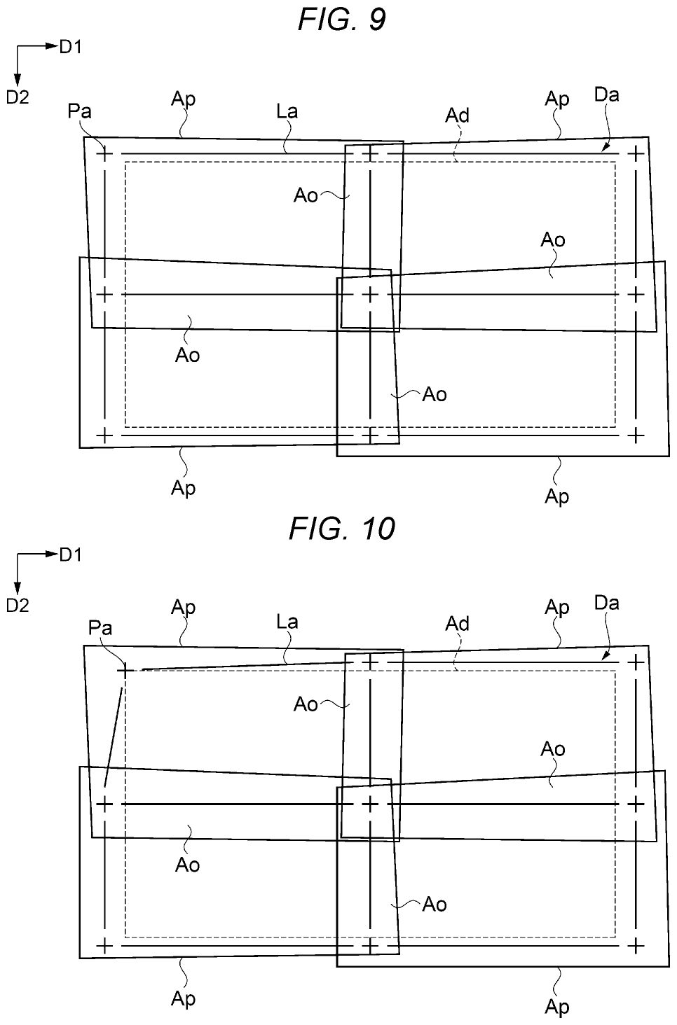

In step S140, the control unit 10 first provisionally decides the size of the image for adjustment Da and decides the coordinates of each adjustment point Pa in the common coordinate system, based on that size. The control unit 10 then outputs the coordinates of the adjustment point Pa that can be included in each projection area Ap, to each projector 2, and causes each correction control unit 28 to generate image data of the partial image Id corresponding to a part of the image for adjustment Da. When the correction control unit 28 of each projector 2 controls the corresponding image correction unit 26 and outputs generated image data to the projection unit 27, the image for adjustment Da is displayed on the projection surface Sp by multi-projection, as shown in FIG. 9. In this embodiment, the adjustment points Pa and the auxiliary lines La included in the overlap area Ao are projected as overlapping each other by the plurality of projectors 2 sharing this overlap area Ao. However, the adjustment points Pa and the auxiliary lines La included in the overlap area Ao may be projected by only one of the projectors 2. In FIG. 9, a projection range Ad desired by the user, that is, a range where the full image Iw is to be displayed, is indicated by dashed lines.

In this embodiment, as shown in FIG. 9, the number of adjustment points Pa is 3 in the first direction D1, in which two partial images Id are arranged, and these adjustment points Pa are arranged at equal intervals in the first direction D1. Therefore, when the adjustment points Pa at both ends of the three adjustment points Pa are arranged near two ends in the first direction D1 of the full image Iw, the adjustment point Pa in the center is arranged at an intermediate position between the two partial images Id next to each other in the first direction D1, that is, in the overlap area Ao. The same applies to the second direction D2. An adjustment point Pa is arranged in the overlap area Ao located at an intermediate position between the two partial images Id next to each other in the second direction D2.

The way the image for adjustment Da is displayed by multi-projection is not limited to the above example. For example, the control unit 10 may generate image data for adjustment representing the image for adjustment Da as described above, then generate partial image data of a part corresponding to the arrangement of the partial image Id of each projector 2, based on the generated image data for adjustment, and output the partial image data corresponding to each projector 2, to each projector 2. In this case, when each projector 2 projects the partial image Id based on the inputted partial image data, the image for adjustment Da is displayed on the projection surface Sp by multi-projection.

In step S150, the control unit 10 accepts an operation of moving an adjustment point Pa from the user via the operation unit 14. The user selects one adjustment point Pa to be the target of the movement operation and designates a direction of movement and a distance of movement of the selected adjustment point Pa, by the operation unit 14. Alternatively, the user may designate a position to which the selected adjustment point Pa is to be moved, directly on the projection surface Sp by a pointer or the like. The control unit 10 may cause the correction control unit 28 to display a range where each adjustment point Pa is movable, for the sake of convenience of the user.

In step S160, the control unit 10 changes the mode of the image for adjustment Da, based on the user's operation. Specifically, the control unit 10 outputs the coordinates of the adjustment point Pa after the movement, to the projector 2 whose projection area Ap includes the selected adjustment point Pa, and instructs the projector 2 to update the partial image Id. When the correction control unit 28 of the projector 2 receiving the instruction moves the adjustment point Pa to the inputted coordinates and updates the partial image Id, the image for adjustment Da in the changed mode is displayed on the projection surface Sp by multi-projection. For example, when the top left adjustment point Pa is moved to the top left corner of a desired projection range Ad by the user's operation, the image for adjustment Da is deformed as shown in FIG. 10.

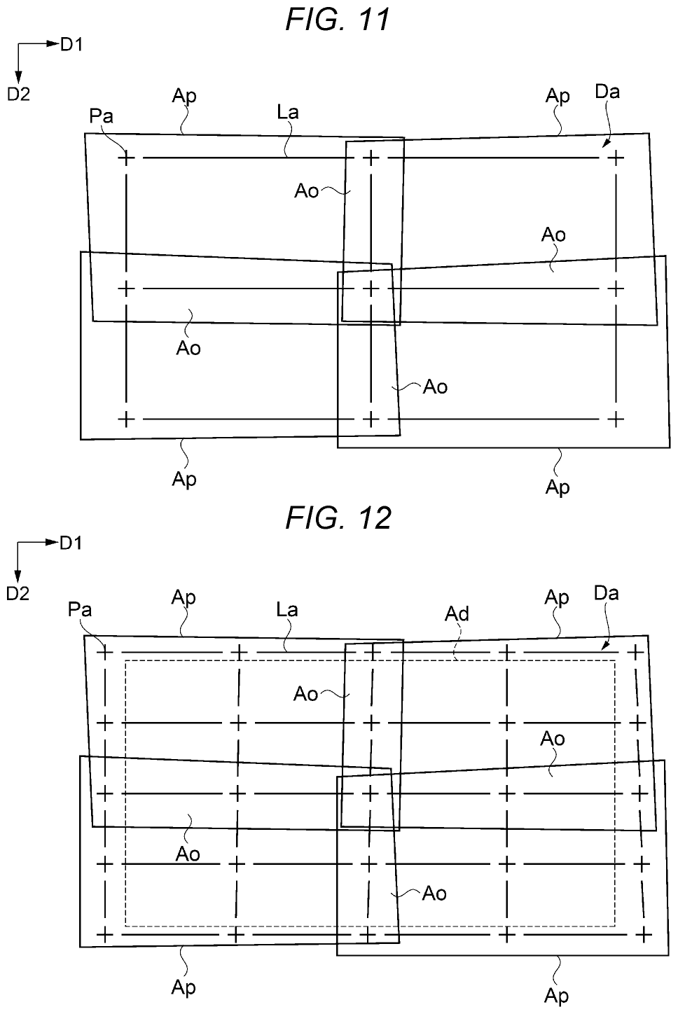

In step S170, the control unit 10 determines whether or not the adjustment of the full image Iw using the image for adjustment Da is finished, based on the user's operation by the operation unit 14. When an instruction to end is not given by the user, the control unit 10 returns the processing to step S150 and accepts an operation of moving an adjustment point Pa. By repeating steps S150 to S170, the user can move a plurality of adjustment points Pa to desired positions and thus can designate a mode of the image for adjustment Da. Meanwhile, when an instruction to end is given by the user, the positions of all the adjustment points Pa are finalized and the control unit 10 shifts the processing to step S180. For example, when all the adjustment points Pa are moved according to the desired projection range Ad by the user's operation, the image for adjustment Da is displayed in a properly adjusted mode as shown in FIG. 11.

In step S180, the control unit 10 causes the correction control unit 28 of each projector 2 to decide a correction parameter for geometric correction, based on the finalized position of the adjustment point Pa, that is, the change in the mode of the image for adjustment Da, and then ends the processing. On receiving an instruction for this, the correction control unit 28 of each projector 2 updates the correction parameter decided in step S250, based on the coordinates of the adjustment point Pa, and outputs the updated correction parameter to the image correction unit 26. From this point onward, the image correction unit 26 of each projector 2 performs a geometric correction based on this correction parameter, on the image data inputted from the image input unit 25, and the projector 2 thus projects the partial image Id in the mode corresponding to the position of the adjustment point Pa. Thus, the full image Iw is adjusted and displayed in the mode designated by the user. As each projector 2 projects the partial image Id based on the decided correction parameter in this way, the mode of the full image Iw is adjusted. Therefore, each correction parameter is equivalent to a parameter for adjusting the mode of the full image Iw.

In this embodiment, the case where both the first density information and the second density information included in the projection information are 1 is described. However, for example, when both the first density information and the second density information are 2, the number of adjustment points Pa is 5 in both the first direction D1 and the second direction D2 and the total number is 5×5=25, as shown in FIG. 12. In this case, too, the adjustment points Pa are arranged in the overlap area Ao, as shown in FIG. 12. Correction parameters for geometric correction can be decided, using four adjustment points Pa next to each other in the first direction D1 and the second direction D2. Therefore, in this case, the correction control unit 28 generates four correction parameters for one partial image Id and the image correction unit 26 performs a correction using the different correction parameters according to the positions in the partial image Id.

Although not illustrated, when both the first density information and the second density information are 3, the number of adjustment points Pa is 7 in both the first direction D1 and the second direction D2 and the total number is 7×7=49. In this case, too, the adjustment points Pa are arranged in the overlap area Ao. In this case, nine correction parameters are generated for one partial image Id and the different correction parameters are used according to the positions in the partial image Id.

In this way, when c partial images Id are arranged in the first direction D1, setting the number of adjustment points Pa in the first direction D1 to c×m+1, where m is a natural number, leads to arranging an odd number of adjustment points Pa equal to or greater than 3 are arranged in two partial images Id next to each other in the first direction D1. Also, since these adjustment points Pa are arranged at equal intervals in the first direction D1, the adjustment points Pa are arranged in the overlap area Ao located at the intermediate position between the two partial images Id next to each other in the first direction D1. The same applies to the second direction D2. When b partial images Id are arranged in the second direction D2, setting the number of adjustment points Pa in the second direction D2 to b×n+1, where n is a natural number, leads to arranging the adjustment points Pa in the overlap area Ao located at the intermediate position between the two partial images Id next to each other in the second direction D2. That is, the adjustment points Pa are arranged in the overlap area Ao regardless of the values of the natural numbers expressing the first density information and the second density information. As the values of the natural numbers expressing the first density information and the second density information become greater, a finer correction can be made.

As described above, the projection system 100, the computer 1, and the method for adjusting the full image Iw according to this embodiment can achieve the following effects.

(1) According to this embodiment, the control unit 10 decides the numbers of adjustment points Pa in the first direction D1 and the second direction D2 in such a way that the adjustment points Pa are arranged in the overlap area Ao where the partial images Id overlap each other, based on the numbers of partial images Id arranged in the first direction D1 and the second direction D2. Since the adjustment points Pa are thus arranged in the overlap area Ao, a plurality of partial images Id sharing the overlap area Ao can be smoothly coupled together in the overlap area Ao.

(2) According to this embodiment, the projection information acquired from the user includes information about the density of arrangement of the adjustment points Pa. Therefore, the adjustment points Pa can be arranged at a desired density of arrangement according to the three-dimensional shape or the like of the projection surface Sp.

(3) According to this embodiment, the numbers of adjustment points Pa in the first direction D1 and the second direction D2 are set to the number of partial images Id in each direction multiplied by a natural number plus 1. Therefore, the adjustment points Pa can be arranged at the intermediate position between the partial images Id next to each other, that is, in the overlap area Ao.

### 2. Second Embodiment

A projection system according to a second embodiment will now be described.

The projection system 100 according to this embodiment has the same configuration as in the first embodiment but partly differs in the operations in the projection image adjustment processing.

In this embodiment, when acquiring the projection information from the user in step S110, the control unit 10 acquires the first arrangement information representing the number of partial images Id along the first direction D1 and the second arrangement information representing the number of partial images Id along the second direction D2 as in the first embodiment but does not acquire the information about the density of arrangement of the adjustment points Pa, that is, the first density information and the second density information.

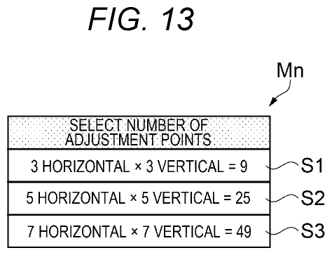

Instead, the control unit 10 causes the display unit 12 to display a menu image Mn shown in FIG. 13 for allowing the user to select a number of adjustment points Pa when deciding the number of adjustment points Pa in step S130.

As shown in FIG. 13, the menu image Mn includes three options selectable by the user. Of these options, “3 horizontal×3 vertical=9” is given as a first option S1, “5 horizontal×5 vertical=25” is given as a second option S2, and “7 horizontal×7 vertical=49” is given as a third option S3. That is, the number of adjustment points Pa in the first direction D1, the number of adjustment points Pa in the second direction D2, and the total number of adjustment points Pa are given as each option. This menu image Mn is generated by the control unit 10, based on the number of partial images Id along the first direction D1 and the number of partial images Id along the second direction D2 acquired as the projection information from the user.

Specifically, the control unit 10 decides, as the first option S1, an option in which the number of adjustment points Pa in the first direction D1 is c×1+1 and in which the number of adjustment points Pa in the second direction D2 is b×1+1, where c is the number of partial images Id along the first direction D1 acquired from the user and b is the number of partial images Id along the second direction D2. The control unit 10 also decides, as the second option S2, an option in which the number of adjustment points Pa in the first direction D1 is c×2+1 and in which the number of adjustment points Pa in the second direction D2 is b×2+1. The control unit 10 also decides, as the third option S3, an option in which the number of adjustment points Pa in the first direction D1 is c×3+1 and in which the number of adjustment points Pa in the second direction D2 is b×3+1. In this way, in all the options included in the menu image Mn, the number of adjustment points Pa in the first direction D1 satisfies c×x+1, where x is a natural number, and the number of adjustment points Pa in the second direction D2 satisfies b×y+1, where y is a natural number.

In each option, the same natural number is employed as x and y. However, x and y may differ from each other. Also, the number of options to be decided may be any plural number and may be other than three.

The user can select one of the three options by operating the operation unit 14. The control unit 10 causes the display unit 12 to display the menu image Mn and subsequently accepts an operation by the user selecting an option via the operation unit 14. The control unit 10 then decides the numbers of adjustment points Pa in the first direction D1 and the second direction D2, based on the option selected by the user.

As described above, the projection system 100, the computer 1, and the method for adjusting the full image Iw according to this embodiment can achieve effects similar to those in the first embodiment.

The foregoing embodiments may be modified as follows.

In the embodiments, at least one projector 2 may execute apart of the operations to be executed by the computer 1, and the computer 1 may execute a part of the operations to be executed by each projector 2 so as to control each projector 2. Also, one projector 2 may be configured to execute all the operations to be executed by the computer 1 and control the operations of the other projectors 2. This enables the projection system 100 to be configured without including the computer 1.

In the embodiments, the control unit 10 decides a correction parameter in step S180 after all the movements of adjustment points Pa by the user are finished in step S170. However, the control unit 10 may update the correction parameter every time the movement of one adjustment point Pa is finished, and may display an image using this correction parameter. In this configuration, for example, when an image having a meaningful background image with the adjustment points Pa and the auxiliary lines La superimposed thereon is used as the image for adjustment Da, a geometric correction is made to the background image every time one adjustment point Pa is moved. Therefore, the status of correction of the distortion of the image can be checked in real time.

In the embodiments, the number of partial images Id arranged in the first direction D1 is acquired as the first arrangement information and the number of partial images Id arranged in the second direction D2 is acquired as the second arrangement information. However, the number of overlap areas Ao along the first direction D1 may be acquired as the first arrangement information and the number of overlap areas Ao along the second direction D2 may be acquired as the second arrangement information. For example, when four partial images Id are arranged in two lines in both the first direction D1 and the second direction D2 as in the embodiments, both the number of overlap areas Ao along the first direction D1 and the number of overlap areas Ao along the second direction D2 are 1. In this case, the number of partial images Id in each direction can be calculated by adding 1 to the acquired number of overlap areas Ao.

In the embodiments, the transmission-type liquid crystal light valves 32R, 32G, 32B are used as light modulation devices. However, a reflection-type light modulation device such as a reflection-type liquid crystal light valve can be employed. Also, a digital micromirror device or the like that controls the exit direction of incident light for each micromirror as a pixel and thus modulates the light emitted from the light source 31 can be used. The configuration having a plurality of light modulation devices corresponding to individual color lights is not limiting. A configuration having a single light modulation device modulating a plurality of color lights in time division may be employed.

What is claimed is:

1. A projection image adjustment method comprising:
acquiring projection information including first arrangement information corresponding to a number of a plurality of partial images projected on a projection surface from a plurality of projectors, the plurality of partial images are arranged in a first direction in such a way as to partly overlap each other;
deciding a number of a plurality of adjustment points in the first direction in such a way that the plurality of adjustment points are arranged in an overlap area where the plurality of partial images overlap each other, based on the first arrangement information;
projecting, by the plurality of projectors, an image for adjustment including the plurality of adjustment points in the number are arranged in the first direction, as a projection image formed by the plurality of partial images on the projection surface;
accepting an operation of moving the plurality of adjustment points included in the image for adjustment;
changing a visual aspect of the image for adjustment, based on the operation; and
deciding a correction parameter for adjusting a visual aspect of the projection image, based on the change in the visual aspect of the image for adjustment.

2. The projection image adjustment method according to claim 1, wherein
the first arrangement information is information representing the number of the plurality of partial images arranged in the first direction.

3. The projection image adjustment method according to claim 1, wherein
the first arrangement information is information representing a number of the overlap areas along the first direction.

4. The projection image adjustment method according to claim 1, wherein
the deciding the number of the plurality of adjustment points in the first direction includes:
deciding a plurality of options for the number of the plurality of adjustment points, based on the first arrangement information;
accepting an operation of selecting one option from among the plurality of options; and
deciding the number of the plurality of adjustment points in the first direction, based on the one option.

5. The projection image adjustment method according to claim 4, wherein
each of the plurality of options satisfies c×x+1, c being the number of the plurality of partial images arranged in the first direction decided according to the first arrangement information, and x being a natural number.

6. The projection image adjustment method according to claim 1, wherein
the projection information includes first density information about a density of arrangement of the plurality of arrangement points in the first direction, and
the number of the plurality of adjustment points in the first direction is decided, based on the first arrangement information and the first density information.

7. The projection image adjustment method according to claim 6, wherein
the number of the plurality of adjustment points in the first direction is c×m+1, c being the number of the plurality of partial images arranged in the first direction decided according to the first arrangement information, and m being a natural number corresponds to the first density information.

8. The projection image adjustment method according to claim 1, wherein
the plurality of partial images are arranged in such a way as to partly overlap each other in a second direction intersecting the first direction,
the projection information includes second arrangement information corresponding to a number of the plurality of partial images arranged in the second direction,
in the image for adjustment, the plurality of adjustment points are arranged in the second direction, and
the number of the plurality of adjustment points in the second direction is decided in such a way that the plurality of adjustment points are arranged in the overlap area, based on the second arrangement information.

9. The projection image adjustment method according to claim 8, wherein
the second arrangement information is information representing the number of the plurality of partial images arranged in the second direction.

10. The projection image adjustment method according to claim 8, wherein
the second arrangement information is information representing a number of the overlap areas along the second direction.

11. The projection image adjustment method according to claim 8, wherein
the deciding the number of the plurality of adjustment points in the second direction includes:
deciding a plurality of options for the number of the plurality of adjustment points, based on the second arrangement information;
accepting an operation of selecting one option from among the plurality of options; and
deciding the number of the plurality of adjustment points in the second direction, based on the one option.

12. The projection image adjustment method according to claim 11, wherein
each of the plurality of options satisfies b×y+1, b being the number of the plurality of partial images arranged in the second direction decided according to the second arrangement information, and y being a natural number.

13. The projection image adjustment method according to claim 8, wherein
the projection information includes second density information about a density of arrangement of the plurality of arrangement points in the second direction, and
the number of the plurality of adjustment points in the second direction is decided, based on the second arrangement information and the second density information.

14. The projection image adjustment method according to claim 13, wherein
the number of the plurality of adjustment points in the second direction is b×n+1, b being the number of the plurality of partial images arranged in the second direction decided according to the second arrangement information, and n being a natural number corresponds to the second density information.

15. An information processing device comprising:
one or a plurality of processors programmed to:
acquire projection information including first arrangement information corresponding to a number of a plurality of partial images projected on a projection surface from a plurality of projectors, the plurality of partial images are arranged in a first direction in such a way as to partly overlap each other;
detect a number of a plurality of adjustment points in the first direction in such a way that the plurality of adjustment points are arranged in an overlap area where the plurality of partial images overlap each other, based on the first arrangement information;
project, by the plurality of projectors, an image for adjustment including the plurality of adjustment points in the number are arranged in the first direction, as a projection image formed by the plurality of partial images on the projection surface;
accept an operation of moving the plurality of adjustment points included in the image for adjustment,
change a visual aspect of the image for adjustment, based on the operation; and
control a decision about a correction parameter for adjusting a visual aspect of the projection image, based on the change in the visual aspect of the image for adjustment.

16. A projection system comprising:
a plurality of projectors projecting a plurality of partial images arranged in a first direction in such a way as to partly overlap each other; and
an information processing device including one or a plurality of processors programmed to:
acquire projection information including first arrangement information corresponding to a number of the plurality of partial images arranged in the first direction;
decide a number of a plurality of adjustment points in the first direction in such a way that the plurality of adjustment points are arranged in an overlap area where the plurality of partial images overlap each other, based on the first arrangement information;
project, by the plurality of projectors, an image for adjustment including the plurality of adjustment points in the number are arranged in the first direction, as a projection image formed by the plurality of partial images on a projection surface;
accept an operation of moving the plurality of adjustment points included in the image for adjustment,
change a visual aspect of the image for adjustment, based on the operation; and
decide a correction parameter for adjusting a visual aspect of the projection image, based on the change in the visual aspect of the image for adjustment.
